(19) United States
(12) Patent Application Publication
(10) Pub. No.: US 2019/0128205 A1
(43) Pub. Date: May 2, 2019

(54) METHOD FOR DETERMINING THE PROPER OPERATION OF A VALVE IN A GAS TANK SYSTEM

(71) Applicant: Scania CV AB, Södertälje (SE)

(72) Inventors: Mårten ECKERDAL, Huddinge (SE); Svante LÖTHGREN, Hägersten (SE); Magnus JOHANSSON, Södertälje (SE); Erik SUNNEGÅRDH, Tullinge (SE)

(73) Assignee: Scania CV AB, Södertälje (SE)

(21) Appl. No.: 16/309,758

(22) PCT Filed: Jun. 19, 2017
(86) PCT No.: PCT/SE2017/050655

§ 371 Date: Dec. 13, 2018

(30) Foreign Application Priority Data
Jun. 21, 2016 (SE) 1650872-3

(51) Int. Cl. F02D 41/22; B60K 15/03; F02D 19/02; F02M 21/02; F17C 13/02

(52) U.S. Cl. CPC F02D 41/221; B60K 15/03006; F02D 19/023; F02D 2041/224; F02M 21/023; F17C 13/025; B60K 2015/03026; F02M 21/0215

(57) ABSTRACT

Disclosed is a method for determining operation of a valve in a gas tank system comprising a plurality of gas tank and valve arrangements, each comprising a gas tank and at least one valve arranged at a passage downstream said gas tank. The method comprises: opening the valves at the passages in a first set of gas tank and valve arrangements; determining a first pressure value at a gas transportation arrangement downstream all of said opened valves; closing the passage at all gas tank and valve arrangements, except for one gas tank and valve arrangement; waiting a pre-determined amount of time; determining a second pressure value at said gas transportation arrangement downstream the gas and tank and valve arrangement whose valve have not been closed; and determining whether said at least one valve which has not been closed operates properly based on said first and second determined pressure values.

### CROSS-REFERENCE TO RELATED APPLICATIONS

This application is a national stage application (filed under 35 § U.S.C. 371) of PCT/SE2017/050655, filed Jun. 19, 2017 of the same title, which, in turn, claims priority to Swedish Application No. 1650872-3 filed Jun. 21, 2016; the contents of each of which are hereby incorporated by reference.

### FIELD OF THE INVENTION

The present application relates to a method for determining the proper operation of a valve in a gas tank system. It also relates to a system for determining the proper operation of a valve in a gas tank system, to a computer program and to a computer program product.

### BACKGROUND OF THE INVENTION

Vehicles with gas engines, especially those which use compressed natural gas, CNG, as fuel, have often several gas bottles as storage tanks. It is often demanded by law that these gas bottles are equipped with valves which close automatically as soon as the engine is turned off. During operation of the gas engine, usually all valves of the gas bottles are open so as to supply the gas engine with gas. However, should a valve fail to open, less fuel would be available for the gas engine.

A fuel indication to the driver of the vehicle assumes that all the gas in the gas bottle is available for the engine. Especially calculations about the remaining cruising range for the vehicle, i.e. the distance the vehicle can travel before refuelling, assume that all the gas is available. In case a valve fails to open, a calculation of the remaining cruising range will show wrong values. This can result in that a driver of the vehicle will not be able to drive to a fuel station where he plans to refuel. Instead, the vehicle might stand still on the road and needs to be refuelled there or needs to be towed away. Both alternatives can cause considerable costs and loss of time.

At present it is not possible to detect whether a valve fails to open.

### SUMMARY OF THE INVENTION

There is thus a need to provide a method for determining the proper operation of a valve in a gas tank system.

It is thus an object of the present invention to provide a method, a system, a computer program and a computer program product for determining the proper operation of a valve in a gas tank system. It is also an object of the present invention to provide a gas tank system and a vehicle with a system for determining the proper operation of a valve in a gas tank system

It is further an object of the present invention to provide an alternative method, a system a vehicle, a computer program and a computer program product for determining the proper operation of a valve in a gas tank system.

According to one aspect, the present disclosure relates to a method for determining the proper operation of a valve in a gas tank system. The gas tank system comprises a plurality of gas tank and valve arrangements. Each gas tank and valve arrangement comprises a gas tank and at least one valve arranged at a passage downstream said gas tank. The method comprises the step of opening the valves at the passages in a first set of gas tank and valve arrangements. Said first set is taken out of the plurality of gas tank and valve arrangements. The first set comprises at least two gas tank and valve arrangements. The method further comprises the step of determining a first pressure value at a gas transportation arrangement downstream all of said valves which have been opened. The method further comprises the step of closing the passage at all gas tank and valve arrangements by closing at least one valve at each such passage, except for one gas tank and valve arrangement, for which said at least one valve at the passage of the gas tank and valve arrangement is not closed. Said one gas tank and valve arrangement is comprised in said first set. The method even further comprises waiting a pre-determined amount of time. Alternatively, or additionally, the method comprises letting a pre-determined amount of gas from the gas tank system pass the location where said first pressure has been determined. The method yet even further comprises determining a second pressure value at said gas transportation arrangement downstream the gas and tank and valve arrangement whose valve(s) have not been closed, and determining whether said at least one valve which has not been closed operates properly based on said first and said second determined pressure value.

Thus it is possible to determine whether a valve in the gas tank system operates properly. The method further can be performed on a number of existing gas tank and valve systems. For performing the steps of the method, no extra components are required which are not already present at common gas tank systems. Thus, it is possible to perform the method without the need to exchange or to add components to common gas tank systems. By determining a valve which is not operating properly, negative effects from the non-proper operation of the valve can be avoided, or at least diminished, by performing countermeasures.

In one example, the determining whether said at least one valve which has not been closed operates properly is based on whether said second determined pressure value deviates more than a pre-determined threshold from said first determined pressure value. This is a computationally fast way of determining the proper operation of the valve.

In one example, the steps of the methods are repeated. The gas tank and valve arrangement with the non-closed passage is changed in each repeated run of the steps of the method. This allows determining the proper operation of several different valves.

In one example, the first set of gas tank and valve arrangements corresponds to all gas tank and valve arrangements in the gas tank system. This reduces the risk that excess flow valves will perform actions during the time the method is performed. Thus, the results of the method have a higher confidence.

In one example, the method further comprises the step of determining whether a set of pre-determined conditions is fulfilled. The other steps of the method are only performed once said set of pre-determined conditions is fulfilled. This reduces the risk that other methods performed at the gas tank system or at platforms which carry the gas tank system will interfere in a negative way with the method.

In one example, the step of determining whether a set of pre-determined conditions is fulfilled is performed intermittently or continuously. The method is aborted when it is determined that said set of pre-determined conditions is not-fulfilled. This reduces the risk that other methods performed at the gas tank system or at platforms which carry the gas tank system will interfere in a negative way with the method.

In one example, the method further comprises the step of indicating for an operator or a service technician of the gas tank system the valve or valves which have been determined as not properly operating. This highly facilitates taking countermeasures against the non-proper operating valve(s). Examples of countermeasures are replacements or service of the valve(s), and/or a correction of values such as a cruising range of a platform carrying the gas tank system, such as a remaining available amount of fuel, or the like.

In one example, the method is used for determining the proper operation of a valve in a gas tank system of a vehicle. The advantages described so far are especially practical for a vehicle.

According to an aspect, the present disclosure relates to a system for determining the proper operation of a valve in a gas tank system. The gas tank system comprises a plurality of gas tank and valve arrangements. Each gas tank and valve arrangement comprises a gas tank and at least one valve arranged at a passage downstream said gas tank. The system for determining the proper operation of a valve in a gas tank system comprises means for opening the valves at the passages in a first set of gas tank and valve arrangements. Said first set is taken out of the plurality of gas tank and valve arrangements. The first set comprises at least two gas tank and valve arrangements. Said system for determining the proper operation of a valve in a gas tank system further comprises means for determining a first pressure value at a gas transportation arrangement downstream all of said valves which have been opened. Said system for determining the proper operation of a valve in a gas tank system further comprises means for closing the passage at all gas tank and valve arrangements by closing at least one valve at each such passage, except for one gas tank and valve arrangement, for which said at least one valve at the passage of the gas tank and valve arrangement is not closed. The one gas tank and valve arrangement is comprised in the first set. Said system for determining the proper operation of a valve in a gas tank system even further comprises means for determining that a pre-determined amount of time has passed, and/or means for determining that a pre-determined amount of gas from the gas tank system has passed the location where the first pressure has been determined. Said system for determining the proper operation of a valve in a gas tank system yet even further comprises means for determining a second pressure value at said gas transportation arrangement downstream the gas and tank and valve arrangement whose valve(s) have not been closed. Said system for determining the proper operation of a valve in a gas tank system also comprises means for determining whether said at least one valve which has not been closed operates properly based on said first and said second determined pressure value.

According to an embodiment, said system for determining the proper operation of a valve in a gas tank system further comprises means for determining whether a set of pre-determined conditions is fulfilled.

According to an embodiment, said system for determining the proper operation of a valve in a gas tank system further comprises means for indicating for an operator or a service technician of the gas tank system the valve or valves which have been determined as not properly operating.

According to one aspect, the present disclosure relates to a gas tank system which comprises the system for determining the proper operation of a valve in a gas tank system.

According to one aspect, the present disclosure relates to a vehicle which comprises the system for determining the proper operation of a valve in a gas tank system and/or the gas tank system.

According to one aspect, the present disclosure relates to a computer program for determining the proper operation of a valve in a gas tank system. The gas tank system comprises a plurality of gas tank and valve arrangements. Each gas tank and valve arrangement comprises a gas tank and at least one valve arranged at a passage downstream said gas tank. The computer program comprises program code for causing an electronic control unit or a computer connected to the electronic control unit to perform the steps according to the method according to the present disclosure.

According to an aspect, the present disclosure relates to a computer program product containing a program code stored on a computer-readable medium for performing method steps according to the method of the current disclosure, when said computer program is run on an electronic control unit or a computer connected to the electronic control unit

The system, the vehicle, the gas tank system, the computer program and the computer program product have corresponding advantages as have been described in connection with the corresponding examples of the method according to this disclosure.

Further advantages of the present invention are described in the following detailed description and/or will arise to a person skilled in the art when performing the invention.

### BRIEF DESCRIPTION OF THE DRAWINGS

For a more detailed understanding of the present invention and its objects and advantages, reference is made to the following detailed description which should be read together with the accompanying drawings. Same reference numbers refer to same components in the different figures. In the following,

FIG. 1 shows, in a schematic way, a vehicle according to one embodiment of the present invention;

FIG. 2 shows, in a schematic way, an engine system comprising a system according to one embodiment of the present invention;

FIG. 3 shows, in a schematic way, a relation between pressure and the remaining fuel in a vehicle with a gas engine;

FIG. 4a shows, in a schematic way, a possible outcome of a pressure measurement according to the present invention when a valve is operating properly;

FIG. 4b shows, in a schematic way, a possible outcome of a pressure measurement according to the present invention when a valve is not operating properly;

FIG. 5 shows, in a schematic way, a flow chart over an example of a method according to the present invention; and

FIG. 6 shows, in a schematic way, a device which can be used in connection with the present invention.

### DETAILED DESCRIPTION OF THE INVENTION

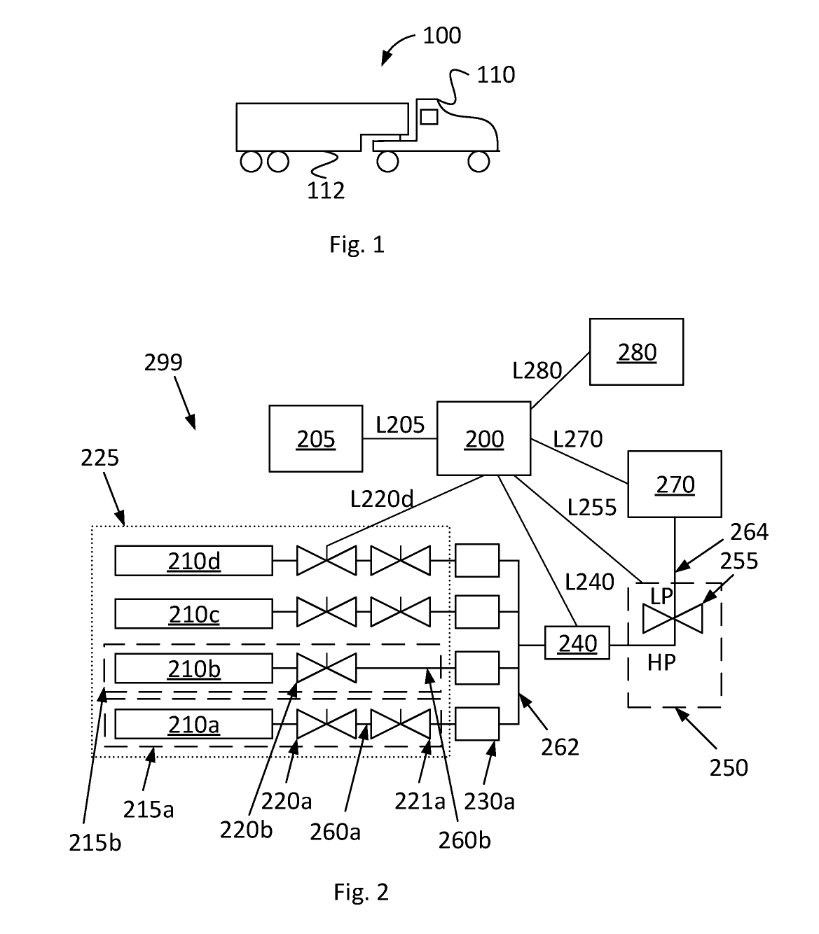

FIG. 1 shows a side view of a vehicle 100. In the shown example, the vehicle comprises a tractor unit 110 and a trailer unit 112. The vehicle 100 can be a heavy vehicle such as a truck. In one example, no trailer unit is connected to the vehicle 100. The vehicle 100 can comprise a gas engine. The vehicle comprises a gas tank system. The vehicle 100 comprises an engine system 299, see FIG. 2a. The engine system 299 can be arranged in the tractor unit 110.

In one example, the vehicle 100 is a bus. The vehicle 100 can be any kind of vehicle comprising a gas tank system. Other examples of vehicles comprising a gas tank system are boats, passenger cars, construction vehicles, and locomotives. The present invention can also be used in connection with any other platform than vehicles, as long as this platform comprises a gas tank system. One example is a power plant with a gas tank system.

The innovative method and the innovative system according to one aspect of the invention are also well suited to, for example, systems which comprise industrial engines and/or engine-powered industrial robots.

Although in the following mainly described in connection with gas engines, it should be emphasised that there is no requirement to have a gas engine connected to the gas tank system for performing the idea of the present disclosure.

The term “link” refers herein to a communication link which may be a physical connection such as an opto-electronic communication line, or a non-physical connection such as a wireless connection, e.g. a radio link or microwave link.

FIG. 2 shows schematically an embodiment of an engine system 299 comprising a gas tank system 225 and comprising a system for determining the proper operation of a valve in a gas tank system according to the present invention. It should be emphasized that not all the components of the engine system 299 are necessary in a system for determining the proper operation of a valve in a gas tank system. The necessary components are solely those in the accompanying claims. However, since the system for determining the proper operation of a valve in a gas tank system necessarily will interact with the gas tank system, both the gas tank system and the system for determining the proper operation of a valve in the gas tank system are combined in the engine system 299 and explained in relation to FIG. 2.

Said engine system 299 comprises a gas tank system 225. Said gas tank system 225 comprises a plurality of gas tank and valve arrangements 215a, 215b, . . . . In the shown example, four gas tank and valve arrangements are sketched, of which a first gas tank and valve arrangement 215a and a second gas tank and valve arrangement 215b are denoted by reference numbers. The number of gas tank and valve arrangements is arbitrary. In one example, eight to ten gas tank and valve arrangements are comprised in the gas tank system 225. For the present disclosure to work, the minimum number of gas tank and valve arrangements in the gas tank system 255 is two.

Each gas tank and valve arrangement comprises a gas tank and at least one valve arranged at a passage downstream said gas tank. The first gas tank and valve arrangement 215a comprises a first gas tank 210a, a first electrically controlled valve 220a, and a first manually controlled valve 221a. Both the first electrically controlled valve 220a and the first manually controlled valve 221a are arranged at a first passage 260a downstream said first gas tank 210a.

The second gas tank and valve arrangement 215b comprises a second gas tank 210b and a second electrically controlled valve 220b. The second electrically controlled valve 220b is arranged at a second passage 260b downstream said second gas tank 210b.

Corresponding components are comprised in the not-numbered third and fourth gas tank and valve arrangements. As an example, a third gas tank 210c and a fourth gas tank 210d together with several further valves are depicted. The number of valves in the gas tank and valve arrangements is arbitrarily as long as at least one valve is provided. Preferably, at least one of the valves in each gas tank and valve arrangement is an automatically controlled valve. Examples of automatically controlled valves are electrically controlled valves, pneumatically controlled valves, hydraulically controlled valves and so on. In the shown example the first manually controlled valve 221a is downstream the first electrically controlled valve 220a. The present disclosure will also work in case the first manually controlled valve 221a would be upstream the first electrically controlled valve 220a.

The electrically controlled valves of the gas tank system 225 can be arranged to open upon receiving of an electrical voltage. This voltage is in one example 24 Volt. The electrically controlled valves of the gas tank system 225 can be arranged to close upon not receiving a pre-determined electrical voltage. As thus, any of said electrical controlled valves will likely close or, in case that valve is not proper operating, remain closed. The term not proper operating does in one example relate to not proper opening. A not proper operating valve usually prevents gas from exiting through the passage of the gas tank and valve arrangement which comprises that valve.

Said passage in the gas tank and valve arrangement can be any suitable passage for transporting gas. The passage can, for example, be a pipe, a hose, a tube, a channel, or the like. The passage can be rigid or flexible.

The engine system 299 comprises four excess flow valves. A first excess flow valve 230a is arranged downstream the first passage 260a. The first excess flow valve 230a is arranged to stop the gas flow in the first passage 260a in case the flow exceeds a pre-determined threshold. In that case the first excess flow valve 230a will close and thus prevent a gas flow in the first passage 260a past the first excess flow valve 230a. Corresponding excess flow valves are arranged downstream the second, third and fourth gas tank and valve arrangements. In one embodiment, only one excess flow valve is present. This only one excess flow valve can be situated downstream the gas tank system 225 at a location where the passages from the different gas tank and valve arrangements are combined. In FIG. 2 this would, for example, correspond to a position left or right of element 240.

The excess flow valves can also be upstream one or several of the valves in the gas tank and valve arrangements.

The engine system 299 further comprises a pressure sensor 240. The pressure sensor 240 is situated downstream the gas tank system 225. The pressure sensor 240 is situated at a gas transportation arrangement. The gas transportation arrangement comprises in one example any of the components described in relation to the passages, such as a pipe, a hose, and the like. In the shown example, the pressure sensor 240 is situated downstream the gas tank system 225 at a location where the passages from the different gas tank and valve arrangements have been combined. The pressure sensor 240 can be any suitable sensor for determining a pressure of the gas at the location of the sensor. The pressure sensor 240 is arranged to determine a first pressure value of the gas passing the sensor. The pressure sensor 240 is arranged to determine a second pressure value of the gas passing the sensor. The pressure sensor 240 is in one example arranged to perform said determining of the first and/or said second pressure value in combination with a first control unit 200 which will be described in further detail later on.

It should be noted that the pressure sensor 240 does not necessarily have to be situated in the transport arrangement as shown in the figure. In one example, the pressure sensor 240 is situated offset the transport arrangement. This can, for example, be a side pipe (not shown) of the transport arrangement. The offset location is preferably situated in such a way that the pressure of the gas at this location is the same as the pressure of the gas in the transport arrangement, or at least has a known relation to the pressure of the gas in the transport arrangement. A pressure sensor located offset the transport arrangement is thus still at the transport arrangement, although not in it.

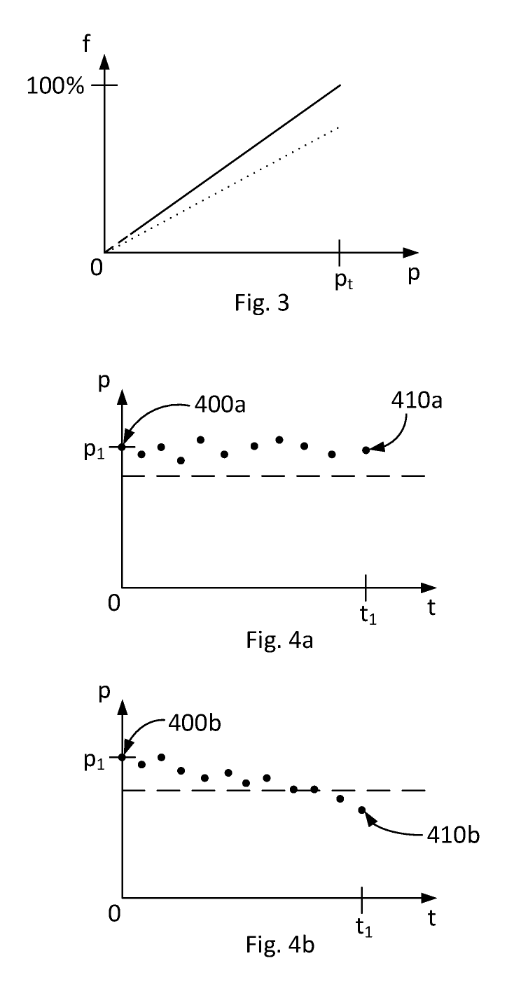

The engine system 299 comprises a gas regulator system 250. The gas regulator system comprises a gas regulator 255. The gas regulator system 250 is arranged downstream the gas tank system 225. The gas regulator system 250 is situated at the gas transport arrangement. The gas regulator 255 has a high pressure, HP, side The HP side is on the side exposed to the gas flow from the gas tank system 225. In one example, the pressure on the HP side is in the range between 0 and 200 bar. This will be more elaborated in relation to FIG. 3. The gas regulator 255 has a low pressure, LP, side. The LP side is on the side which is not exposed to the gas flow from the gas tank system 225. The gas regulator system 250 is arranged to transfer the pressure from the HP side to the LP side.

The engine system 299 comprises a gas engine 270. The gas engine 270 can be arranged to propel a vehicle. The gas engine 270 is in gas flow contact to the gas tank system 225. The gas engine has a preferred input gas pressure. This preferred input gas pressure is supplied by the gas regulator system. In one example, the preferred input gas pressure is 8 bar, or approximately 8 bar. In that case, the gas regulator system 255 is arranged to transfer the gas pressure from the HP side so that it will achieve 8 bar at the LP side.

In the shown example, only one gas pressure sensor 240 is present. In another embodiment, two or more gas pressure sensors are present. A second gas pressure sensor can be arranged upstream or downstream the gas pressure sensor 240. The first and/or second pressure value can then be determined by the second gas pressure sensor.

The first gas pressure value has to be determined at a location downstream all opened valves. By locating the first gas pressure sensor 240 at a location downstream a location where the passages from the different gas tank and valve arrangements are combined, this can be assured. The second gas pressure value does, however, only have to be determined downstream the valves of one gas tank and valve arrangement. The second gas pressure value can thus in one example be determined at a place between the first mechanically operated valve 221a and the first excess flow valve 230a. A disadvantage of such a location for determining the second gas pressure value will be that a second gas pressure sensor has to be used. Further, preferably corresponding gas pressure sensors would be needed downstream the other gas tank and valve arrangements as well.

The engine system 299 comprises a first control unit 200.

Said first control unit 200 is arranged to control operation of said gas engine 270. Said first control unit 200 is arranged for communication with said gas engine 270 via a link L270. Said first control unit 200 is arranged to receive information from said gas engine 270.

Said first control unit 200 is arranged to control operation of said gas regulator system 250. Said first control unit 200 is arranged for communication with said gas regulator system 250 via a link L250. Said first control unit 200 is arranged to receive information from said gas regulator system 250.

Said first control unit 200 is arranged to control operation of said pressure sensor 240. Said first control unit 200 is arranged for communication with said pressure sensor 240 via a link L240. Said first control unit 200 is arranged to receive information from said pressure sensor 240. In case the engine system 299 comprises several pressure sensors, said first control unit 200 can be arranged for communication with each of these several pressure sensors. Said first control unit 200 can then be arranged to receive information from said several pressure sensors.

Said first control unit 200 and/or said pressure sensor 240 is arranged to determine a first pressure value at a gas transportation arrangement. Said first control unit 200 and/or said pressure sensor 240 is arranged to determine a second pressure value at a gas transportation arrangement.

Said first control unit 200 is arranged to control operation of said gas tank system 225. Especially, said first control unit 200 is arranged to control operation of the gas tank and valve arrangements 215a, 215b, . . . . Especially, said first control unit 200 is arranged to control operation of the valves in the gas tank and valve arrangements 215a, 215b, . . . . Said first control unit 200 is arranged for communication with said valves in the gas tank and valve arrangements via at least one link. In the shown example, only one link L220d is sketched for communication between the first control unit 200 and a specific valve. Said first control unit 200 is arranged to receive information from said specific valve. It should, however, be understood that what has been said regarding the specific valve is true for at least one valve in each gas tank and valve arrangement. The other links have just been omitted for not overloading the figure. Alternatively, there can be a common link to the gas tank system 225 and/or to each of the gas tank and valve arrangements.

Said first control unit 200 is arranged for opening the valves at the passages in a first set of gas tank and valve arrangements, wherein said first set is taken out of the plurality of gas tank and valve arrangements, and wherein the first set comprises at least two gas tank and valve arrangements.

Said first control unit 200 is arranged for closing the passage at all gas tank and valve arrangements by closing at least one valve at each such passage, except for one gas tank and valve arrangement, for which said at least one valve at the passage of the gas tank and valve arrangement is not closed. Said one gas tank and valve arrangement is comprised in said first set.

Said first control unit 200 is in one example arranged for determining that a pre-determined amount of time has passed. Said first control unit 200 can comprise a timer unit for achieving this. Said first control unit 200 is in one example arranged for determining that a pre-determined amount of gas from the gas tank system has passed the location where said first pressure has been determined. In one example this is be done via controlling a flow sensor (not shown). In one example this is done via analysing data from the gas engine 270. It is known in the art how to use operating data from an engine for determining the amount of fuel which is consumed by the engine. Since the gas engine 270 in general is the only consumer of gas downstream the location where the first pressure has been determined, it is possible to determine the amount of gas which has passed that location based on said data from the engine.

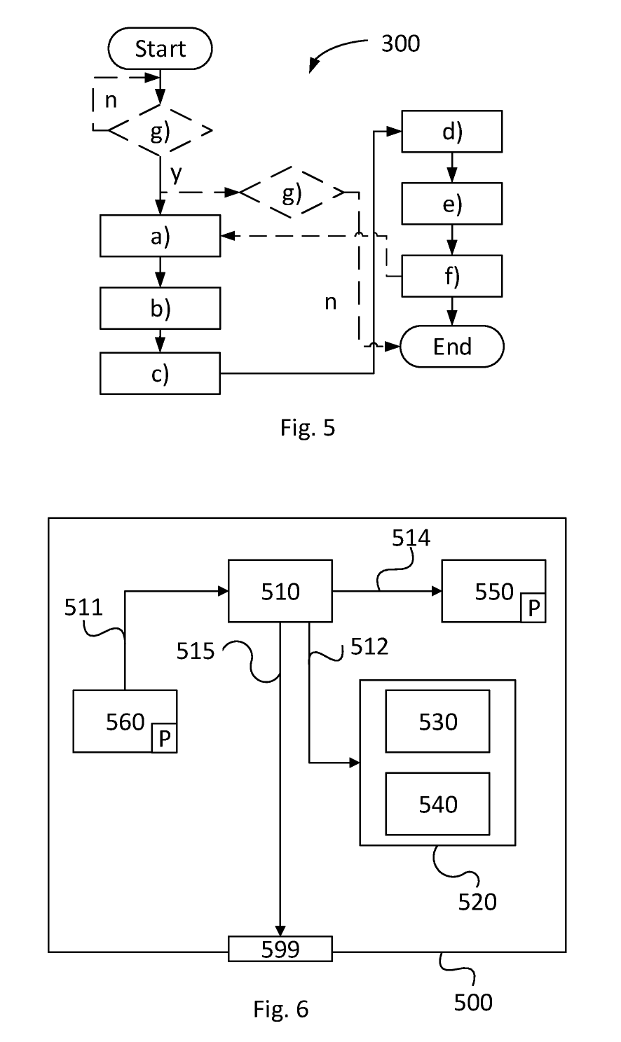

Said first control unit 200 is arranged for determining whether said at least one valve which has not been closed operates properly based on said first and said second determined pressure value. This is explained in more detail in relation to FIG. 4-5.

Said first control unit 200 is arranged for determining whether a set of pre-determined conditions is fulfilled. The set of pre-determined conditions can comprise any of the following examples. In one example, said first control unit 200 is arranged to determine whether the vehicle is in the process of being refuelled. In one example, said first control unit 200 is arranged to determine whether the flow of the gas out of the gas tank system is in a certain interval, or above or below a certain threshold. In one example, the first control unit 200 is arranged for determining whether the pressure on the HP side is above a certain threshold. In one example, the first control unit 200 is arranged for determining whether a total or a partial fuel cut occurs. In one example, the first control unit 200 is arranged for determining whether the load of the gas engine 270 is in a certain interval, or above or below a certain threshold.

Said gas engine system 299 comprises an indicating unit 280. Said indicating unit 280 is arranged for indicating for an operator or a service technician of the gas tank system the valve or valves which have been determined as not properly operating. In one example, the indicating unit comprises a memory which can be read out. In one example, the indicating unit 280 comprises a screen. In one example, the indicating unit comprises audio means and/or tactile means.

Said first control unit 200 is arranged to control operation of said indicating unit 280. Said first control unit 200 is arranged for communication with said indicating unit 280 via a link L280. Said first control unit 200 is arranged to receive information from said indicating unit 280.

Said first control unit 200 can be arranged to communicate the valve(s) which is/are not operating properly to the indicating unit 280.

Said first control unit 200 can be arranged to determine a remaining amount of fuel based on the valves which have been determined as not operating properly. As an example, if it is determined that a number of x gas tank and valve arrangements have valves which are not properly operating out of a number of y gas tank and valve arrangements, it can be determined that the remaining fuel should be compensated by a factor x/y. This is explained more in relation to FIG. 3-5. In case the gas tank and valve arrangements comprise gas tanks of different size or differ in any other relation, this could be included in the determination of the remaining amount of fuel as well. The first control unit 200 can be arranged to communicate the remaining amount of fuel to an operator of the vehicle, for example via the indicating unit 280.

What has been said regarding the remaining amount of fuel is equally valid regarding the remaining cruising range.

In one example, said first control unit 200 is an electronic control unit. It should be understood that the first control unit 200 can comprise several subunits. In one example, a subunit of the first control unit 200 is arranged to control the valves in the gas tank system 225. Any of the functions of the first control unit 200 described so far can be attributed to a subunit of the first control unit 200.

A second control unit 205 is arranged for communication with the first control unit 200 via a link L205 and may be detachably connected to it. It may be a control unit external to the vehicle 100. It may be adapted to conducting the innovative method steps according to the invention. The second control unit 205 may be arranged to perform the inventive method steps according to the invention. It may be used to cross-load software to the first control unit 200, particularly software for conducting the innovative method. It may alternatively be arranged for communication with the first control unit 200 via an internal network on board the vehicle. It may be adapted to performing substantially the same functions as the first control unit 200, such as adapting engine control of a gas engine in a vehicle. The innovative method may be conducted by the first control unit 200 or the second control unit 205, or by both of them.

The engine system 299 can perform any of the method steps described later in relation to FIG. 5.

FIG. 3 shows, in a schematic way, a relation between a pressure p and the remaining fuel fin a vehicle with a gas engine. Similar relations can apply to other gas tank systems. The remaining fuel can relate to a relative amount of remaining fuel. This is indicated by the continuous line. In the shown example, the remaining fuel relates to the total amount of fuel which can be stored in the gas tank system 225. If the gas tank system will be fully loaded with fuel, i.e. gas, the pressure will receive a maximum pressure value pₜ. Said maximum pressure value pₜ will not only be achieved inside the gas tank system, but also at any point on the HP side assuming at least one passage of a gas tank and valve arrangement is open. In one example pₜ is in the range between 200 bar and 220 bar, for example 200 bar or 220 bar. If the amount of fuel is reduced, for example due to the fuel being consumed by a gas engine, the pressure will lower. There is basically a linear relation between the pressure and the amount of fuel remaining in the gas tank system 225. It is thus sufficient to measure the pressure basically anywhere on the HP side. By doing so, the amount of remaining fuel and/or percentage of remaining fuel can be determined. When the pressure on the HP side equals the pressure on the LP side the fuel might no longer be efficiently utilised for propelling the vehicle. This is indicated by the dashed line.

In case a valve is not properly operating, the gas of the gas tank and valve arrangement comprising that valve cannot be used. This has been explained before. However, in case the gas tanks are fully loaded, a measurement of a pressure value on the HP side will still indicate pₜ as the pressure value. This is due to the fact that the maximum pressure will be achieved in each gas tank of the gas tank system. However, less than the full amount of gas can be used, namely solely the gas in the gas tanks which do not have a blocked passage. This is indicated by the dotted line. Although the dotted line shows the true amount of usable fuel, a state of the art gas engine system would basically always assume the continuous line to be true. As a result, a measured pressure value will always be mapped to the remaining amount of fuel following from the continuous line, instead of the dotted line. Consequently, when indicating the amount of fuel to a driver, too much remaining fuel will be presented and/or assumed which will result in the problems discussed earlier. As will be described in more detail later, the present invention will enable determining the true relation between measured pressure value and the remaining amount of fuel available to be consumed by the gas engine.

A method according to the present invention will be described in relation to FIGS. 4a, 4b, and 5. FIG. 5 shows, in a schematic way, a flow chart over an example of a method 300 according to the present invention.

The method 300 is in one example performed at the start of a drive. The method can, for example, be performed a pre-determined amount of time after the start of the vehicle. This has the advantage that a valve which is not operating properly can be detected at the start of the drive, so that a driver can adapt the drive to find a closer gas station in time, if needed. It is usually not needed to perform the method several times during a drive of the vehicle. However, it can be done so anyhow in case a need for it should occur. The method can be performed during driving of the vehicle. Thus the method can be performed while the vehicle is moving. This does, however, not exclude that the vehicle might stand still at least during parts of the method. This can, for example, happen due to traffic lights, traffic jams, or other traffic related occurrences.

The method 300 starts with the optional step g) of determining whether a set of pre-determined conditions is fulfilled. The set of pre-determined conditions can comprise any of the following examples. In one example, it is determined whether load of the gas engine is below a certain threshold, or above a certain threshold, or in a certain interval. In one example, it is determined whether a flow of the gas from the gas tank system is below a certain threshold, or above a certain threshold, or in a certain interval. In one example, it is determined whether the pressure on the HP side is below a certain threshold, or above a certain threshold, or in a certain interval. In one example, it is determined whether a total or a partial fuel cut occurs. A total fuel cut occurs in one example when the vehicle is driving downhill and the gravitational force component in the driving direction of the vehicle is big enough to keep or to achieve a desired speed of the vehicle without the help of the gas engine. In one example, it is determined whether a different diagnosis method than the method of the present disclosure is performed right now. In one example, it is determined whether the vehicle is in the process of being refuelled right now.

In a preferred example, it is determined whether the load of the gas engine is below a certain threshold. That assures that no excess flow valves will cut the gas flow when performing the method. In a preferred example, it is determined whether the gas flow is in a certain interval. That assures that no excess flow valves will cut the gas flow when performing the method. In a preferred example, it is determined whether the pressure on the HP side is above a certain threshold. This threshold is in one example 20 bar. This assures that a performing of the method will not risk influencing the pressure on the HP side so much that it can result in delivering not enough gas to the engine, so that the engine risks dying. In a preferred example, it is determined whether a different diagnosis method than the method of the present disclosure is performed right now. This assures that the engine system is operating under normal condition. It further assures that the present method is not unintentionally influencing another method, and vice versa. In a preferred example, it is determined whether the vehicle is in the process of being refuelled right now. A refuelling risks covering a detection of a pressure dropdown in the present method. This will become clear later. A refuelling might thus risk that a not properly functioning valve will not be detected.

Performing step g) does thus assure that optimal conditions are present for performing the method. Step g) can thus assure that the method will not influence the driving in a negative way. Step g) can also assure that the accuracy of the results of the present method are increased.

In case the set of pre-determined conditions is fulfilled, the method continues with step a). In case the set of pre-determined conditions is not fulfilled the method continues with performing step g) once again.

Step a) comprises opening the valves at the passages in a first set of gas tank and valve arrangements, wherein said first set is taken out of the plurality of gas tank and valve arrangements, and wherein the first set comprises at least two gas tank and valve arrangements. In other words, all the valves in the passages of at least two gas tank and valve arrangements are opened. When applied to the system of FIG. 2, this allows the gas from at least two gas tanks to flow to the HP side of the regulator system 250. In a preferred example said first set of gas tank and valve arrangements corresponds to all gas tank and valve arrangements in the gas tank system. Opening only the valves of two gas tank and valve arrangements is enough when assuming that at most one valve is not operating properly. However, opening the valves of all passages as in the preferred example assures that the method can detect any number of not properly operating valves. Opening the valves of all passages, or at least of more than two passages, is also preferred for lowering the risk that an excess flow valve will influence the gas flow during the time the method 300 is performed.

It should be understood that the term opening a valve relates to instructions to open the valve. Such instructions could be data, electrical signals, applied voltage, or the like. A valve which is not operating properly might thus not follow such instruction. Especially, a valve which is not operating properly will likely not follow an instruction to open. Thus, the term opening the valves in step a) does not necessarily result in the fact that each of said valves actually is in an opened state afterwards.

In a preferred example, the valves are not opened simultaneously, but with some time delay after each other. The time delay is preferably a fraction of a second. The method continues with step b).

In step b) a first pressure value is determined at a gas transportation arrangement downstream all of said valves which have been opened in step a). In the example of FIG. 2, this first pressure value can be determined by the pressure sensor 240 and/or the first control unit 200.

FIG. 4a and FIG. 4b show determined pressure values p over time t. In the shown examples, a first pressure value pi is determined as indicated by the points 400a and 400b, respectively.

As long as at least one passage actually opened in step a), i.e. as long as not all passages in the first set have valves which are not operating properly, the determined first pressure value corresponds to the pressure value in the gas tanks of the gas tank and valve arrangements which have opened passages, or at least can be related to the pressure values in said gas tanks. As explained before, this pressure value will likely be in the range between the pressure value used in step g) to allow continuing to step a) and the maximum pressure value pₜ. The method continues with step c).

In step c) the passage at all gas tank and valve arrangements is closed by closing at least one valve at each such passage, except for one gas tank and valve arrangement, for which said at least one valve at the passage of the gas tank and valve arrangement is not closed. Said one gas tank and valve arrangement is comprised in said first set. This assures that at most gas from one gas tank and valve arrangement can leave the gas tank system. In the example of FIG. 2, at most the gas of one gas tank and valve system can reach the regulator system 250.

In case the valves in the passage of the gas tank and valve system whose valves are not closed are operating properly, the gas will leave the gas tank of said gas tank and valve system through the passage. In case the valves in the passage of the gas tank and valve system whose valves are not closed are not operating properly, the gas will not be able to leave the gas tank of said gas tank and valve system through the passage. This is due to the fact that a valve which is not operating properly will with high likelihood due to its construction remain in the closed state. As this valve will thus not have opened in step a), it will not remain open in step c) either. It should be emphasised that the terms opening a valve and closing a valve in step a) and c) relate to instructions intended to open or to close the valve. Thus, a valve which does not operate properly will likely not follow these instructions.

In a preferred example, it is assured that a pre-determined amount of time passes between step a) is finished and step c) starts. The pre-determined amount of time is preferably chosen so that the pressure at the transport arrangement has achieved a basically constant value. In one example, this pre-determined amount of time is 10 seconds. The method continues with step d).

Step d) comprises waiting a pre-determined amount of time. Alternatively and/or additionally, step d) comprises letting a pre-determined amount of gas from the gas tank system pass the location where said first pressure has been determined.

Said pre-determined amount of time is in one example in the range of 5-10 seconds. In one example, said pre-determined amount of time is below 20 seconds. In case a valve in the passage which is not closed is not operating properly, no further gas from the gas tank system will be able to reach the gas regulator and thus the motor. Since there is already some gas in the transport arrangement on the HP side, the motor will not run out of gas fuel immediately but often after 40-60 seconds. Said pre-determined amount of time should thus be chosen so as to be well below the time after which the motor will die due to not receiving enough gas. On the other hand, as will become clear later, the time has to be at least so long that the gas pressure in the transport arrangement will reduce noticeably in case a valve in the passage which is not closed is not operating properly. This happens typically after some seconds. It should be noted that a measurement of gas pressure has some uncertainty. The term noticeably reduced thus relates to the fact that the pressure has undoubtedly dropped even when taking into account measurement uncertainties and/or similar effects. In one example, a noticeable reduction occurs at a determined pressure drop of at least 5 bar. In one example, a noticeably reduction occurs at a determined pressure drop of at least 2 percent of the maximum allowable gas pressure in the tank. In one example, a noticeable reduction occurs at a determined pressure drop of at least 2 percent of the first determined pressure value. Further examples are given in relation to FIGS. 4a and 4b.

Said pre-determined amount of gas from the gas tank system is preferably an amount of gas big enough to cause a noticeable drop of the gas pressure in the transport arrangement. The term noticeable is as explained above. The amount of gas depends on the characteristics of the engine system. It can be determined when designing the engine system. The amount of gas from the gas tank system which passes the location where said first pressure has been determined is in one example determined by determining the amount of gas consumed by the gas engine. Often, a control unit of a gas engine is able to make this determination based on the control parameters of the gas engine. This has the advantage that no further components are needed in many engine systems.

In principle said pre-determined amount of time and said pre-determined amount of gas are interchangeable. Especially when it is assured that the load of the gas engine is below a certain threshold and/or that the flow of the gas is in a certain interval, it is possible to convert the amount of time approximately into the amount of gas, and vice versa. The method continues with step e).

Step e) comprises determining a second pressure value at said gas transportation arrangement downstream the gas and tank and valve arrangement whose valve(s) have not been closed in step c). Preferably the second pressure value is determined at the same location and/or with the same sensor as the first gas value. This is, however, not a prerequisite. As has been explained before in relation to FIG. 2, there is a slightly higher freedom in choosing the location where to measure the second pressure value as compared to the location where to measure the first pressure value.

In the example of FIGS. 4a and 4b the second pressure value is determined at a time ti after the first pressure value. The second pressure value is indicated by 410a and 410b, respectively. The indicated pressure values for the times in between zero and ti are possible measured pressure values in case a pressure value would have been determined in the meantime.

The method continues with step f).

Step f) comprises determining whether said at least one valve which has not been closed in step c) operates properly based on said first and said second determined pressure value. In one example this is based on whether said second determined pressure value deviates more than a pre-determined threshold from said first determined pressure value. An example can be seen in FIGS. 4a and 4b, respectively. A possible threshold is indicated by the dashed lines in the figures. In one example, the threshold is 3 bar below the first pressure value. FIG. 4a shows the case when the valves in the passage which has not been closed in step c) are operating properly. Since the valves are operating properly, the passage will be open in reality as well. As a result, the gas will be able to flow from the gas tank related to this passage to the gas engine. As a result, the pressure will not deviate significantly between the first pressure value and the second pressure value. Thus, as long as the second pressure value remains above the threshold, it can be concluded that the valves in the passage which is not closed in step c) are operating properly.

As an alternative to the threshold it would be possible to determine the deviation and/or the difference between the first and the second pressure value.

FIG. 4b shows the case when at least one valve in the passage which has not been closed in step c) is not operating properly. Since said at least one valve is not operating properly, the passage will not be open in reality, but will be closed. As a result, the gas will not be able to flow from the gas tank related to this passage to the gas engine. As a result, the pressure will deviate significantly between the first pressure value and the second pressure value. Thus, when the second pressure value drops below the threshold, it can be concluded that at least one valve in the passage which is not closed in step c) is not operating properly.

In one example, the method 300 ends after step f).

In a preferred example, step g) is performed intermittently or continuously during the method 300. The method is then aborted when it is determined in step g) that said set of pre-determined conditions is not-fulfilled. In case the method is repeated for determining the proper operation of several valves, as will be explained later, the method can in total take one or several minutes to perform. It is thus not sure that the set of pre-determined conditions is fulfilled during the whole method based on the fact that it was fulfilled at the start of the method. As an example, a fuel cut, a refuelling, a higher load on the gas engine, or the like, might have occurred. Performing step g) during the method thus increases the reliability of the method.

In one example of the method, the steps a)-f) are repeated. The gas tank and valve arrangement with the non-closed passage in step c) is changed in each repeated run of the steps a)-f). The method is preferably repeated as many times as there are gas tank and valve arrangements. Preferably at each run a different gas tank and valve arrangement is chosen in step c) not to close. This allows determining the proper operation of the valves in all gas tank and valve arrangements. Especially when repeating the steps a)-f) it is preferred to assure that a pre-determined amount of time passes between the end of step a) and the start of step c) in each run. This is to assure that the pressure in the transport arrangement can build up again to reach basically the first pressure value again. Otherwise, several passages which are tested in consecutive runs of the method and with valves which are not operating properly in each of these several passages might cause the gas engine to die.

In one example, the method further comprises the step of indicating for an operator or a service technician of the gas tank system the valve or valves which have been determined as not properly operating in step f) (not shown in FIG. 5). In the example of FIG. 2 this can be done via the indication unit 280. The operator is in one example a driver of a vehicle comprising the gas tank system. This will facilitate for a service technician to replace the valve which is not operating properly without having to spend time to test every valve manually. This will facilitate for an operator to adapt the planned usage of the gas tank system to the fact that not all gas in it will be available. The step of indicating is preferably performed at the end of the method or at the end of each run of the method.

In one example, the method comprises the step of determining a remaining amount of available gas based on the determined valves which are not operating properly. As an example, if it is determined that at least one valve at one out of eight passages is not operating properly, the remaining amount of available gas should be multiplied by a factor of 0.875. Here it is assumed that all gas tank and valve arrangements carry the same amount of gas. If this is not case, compensation factors for this fact can be included in the calculation. The method can also comprise the step of calculating a remaining cruising distance based on the determined valves which are not operating properly. This allows for an easy way for a driver of the vehicle to plan for reaching a fuel station before running out of fuel.

The present disclosure has so far been described in relation to gas. It works especially well for compressed natural gas, CNG. However, the method and the system according to the present disclosure can be used for other gases as well. In principle there are no limitations to what kind of gases can be used. An example of another gas for which the invention can be used is liquefied natural gas, LNG. The described example pressure values and thresholds can be very different when using other gases than CNG, but the principle will remain the same.

When using LNG, the relation from FIG. 3 might not apply. Instead, a gas tank for LNG usually has a level sensor for determining the amount of fuel in the liquid phase in the gas tank. Therefore, the remaining amount of fuel is usually determined based on that level sensor inside the gas tank, or at least related to the inside of the gas tank, instead of based on a pressure measurement outside the gas tank. This might cause more serious problems than with CNG when not using a system according to the present disclosure. To see this one can look at a valve which is not operating properly in a CNG system. Assuming one out of eight passages, as in the example above, are affected by that valve, a system not using the present disclosure will show a remaining amount of fuel which is constantly around 14 percent higher (8/7) than the real amount. However, as the amount of remaining fuel approaches zero, the indication of the remaining amount of fuel will also approach zero. For example, if 10 percent of available fuel is left, the indication would be 11.4 percent, if 1 percent is left, the indication would be 1.14 percent and so on. On the other side, when using a LNG system of, let's say two gas tank and valve arrangements, wherein the valve in the passage of one of those gas tank and valve arrangements is not operating properly, the indicated level of remaining fuel without a system according to the present disclosure will be 50 percent of the total fuel storage capacity higher than the real level, assuming both tanks are filled up with gas at the beginning. For example, when the amount of available remaining fuel is 10 percent, the indication would be 60 percent, if 1 percent would be left, the indication would be 51 percent, and so on. This is due to the fact that the level sensor in the gas tank with the closed passage correctly indicates a full gas tank, but the system, without using the present disclosure, will not be able to detect that the gas in that gas tank is not available to the gas engine due to the valve which is not operating properly.

In other words, whereas a driver in a vehicle with CNG will see a faster drop of an indication of the remaining gas to zero than usual, and thus might at least get a hint that something might be wrong, the driver of a vehicle LNG will be totally surprised since the indication shows a half-full tank, although no gas will be available.

The present method is especially useful for automatically controlled valves as has been described above. However, in case manually controlled valves are present in the gas tank and valve arrangements, the method will also be able to detect whether any of these valves is closed and thus prevents flow of gas through the passage where the closed valve is sitting. A driver getting an indication that a valve is not operating properly at a passage, for example an automatically controlled valve, can thus check whether there is a manually closed valve on that passage.

FIG. 6 is a diagram of one version of a device 500. The control units 200 and 205 described with reference to FIG. 2 may in one version comprise the device 500. The device 500 comprises a non-volatile memory 520, a data processing unit 510 and a read/write memory 550. The non-volatile memory 520 has a first memory element 530 in which a computer program, e.g. an operating system, is stored for controlling the function of the device 500. The device 500 further comprises a bus controller, a serial communication port, I/O means, an A/D converter, a time and date input and transfer unit, an event counter and an interruption controller (not depicted). The non-volatile memory 520 has also a second memory element 540.

The computer program comprises routines for determining the proper operation of a valve in a gas tank system, wherein the gas tank system comprises a plurality of gas tank and valve arrangements, each gas tank and valve arrangement comprising a gas tank and at least one valve arranged at a passage downstream said gas tank.

The computer program P may comprise routines for opening the valves at the passages in a first set of gas tank and valve arrangements, wherein said first set is taken out of the plurality of gas tank and valve arrangements, and wherein the first set comprises at least two gas tank and valve arrangements. This may at least partly be performed by means of said first control unit 200 controlling operation of the valves in the gas tank system 225.

The computer program P may comprise routines for determining a first pressure value at a gas transportation arrangement downstream all of said valves which have been opened. This may at least partly be performed by means of said first control unit 200 controlling operation of the pressure sensor 240. Said first pressure value may be stored in said non-volatile memory 520.

The computer program P may comprise routines for closing the passage at all gas tank and valve arrangements by closing at least one valve at each such passage, except for one gas tank and valve arrangement, for which said at least one valve at the passage of the gas tank and valve arrangement is not closed, wherein said one gas tank and valve arrangement is comprised in said first set. This may at least partly be performed by means of said first control unit 200 controlling operation of the valves in the gas tank system 225.

The computer program P may comprise routines for waiting a pre-determined amount of time. This may at least partly be performed by means of an internal counter or an internal clock. The computer program P may comprise routines for letting a pre-determined amount of gas from the gas tank system pass the location where said first pressure has been determined. This may at least partly be performed by means of said first control unit 200 controlling operation of the regulator system 250 and/or the gas engine 270.

The computer program P may comprise routines for determining a second pressure value at said gas transportation arrangement downstream the gas and tank and valve arrangement whose valve(s) have not been closed. This may at least partly be performed by means of said first control unit 200 controlling operation of the pressure sensor 240. Said first pressure value may be stored in said non-volatile memory 520.

The computer program P may comprise routines for determining whether said at least one valve which has not been closed operates properly based on said first and said second determined pressure value. This might be based on whether said second determined pressure value deviates more than a pre-determined threshold from said first determined pressure value.

The computer program P may comprise routines determining whether a set of pre-determined conditions is fulfilled. This may at least partly be performed by means of said first control unit 200 controlling operation of the pressure sensor 240 and/or the regulator system 250 and/or the gas engine 270.

The program P may be stored in an executable form or in compressed form in a memory 560 and/or in a read/write memory 550.

Where it is stated that the data processing unit 510 performs a certain function, it means that it conducts a certain part of the program which is stored in the memory 560 or a certain part of the program which is stored in the read/write memory 550.

The data processing device 510 can communicate with a data port 599 via a data bus 515. The non-volatile memory 520 is intended for communication with the data processing unit 510 via a data bus 512. The separate memory 560 is intended to communicate with the data processing unit via a data bus 511. The read/write memory 550 is arranged to communicate with the data processing unit 510 via a data bus 514. The links L205, L210, L250-255, and L270, for example, may be connected to the data port 599 (see FIG. 2).

When data are received on the data port 599, they can be stored temporarily in the second memory element 540. When input data received have been temporarily stored, the data processing unit 510 can be prepared to conduct code execution as described above.

Parts of the methods herein described may be conducted by the device 500 by means of the data processing unit 510 which runs the program stored in the memory 560 or the read/write memory 550. When the device 500 runs the program, methods herein described are executed.

The foregoing description of the preferred embodiments of the present invention is provided for illustrative and descriptive purposes. It is neither intended to be exhaustive, nor to limit the invention to the variants described. Many modifications and variations will obviously suggest themselves to one skilled in the art. The embodiments have been chosen and described in order to best explain the principles of the invention and their practical applications and thereby make it possible for one skilled in the art to understand the invention for different embodiments and with the various modifications appropriate to the intended use.

It should especially be noted that the system according to the present disclosure can be arranged to perform any of the steps or actions described in relation to the method 300. It should also be understood that the method according to the present disclosure can further comprise any of the actions attributed to an element of the engine system 299 described in relation to FIG. 2. The same applies to the computer program and the computer program product.

1. A method for determining the proper operation of a valve in a gas tank system, wherein the gas tank system comprises a plurality of gas tank and valve arrangements, each gas tank and valve arrangement comprising a gas tank and at least one valve arranged at a passage downstream of said gas tank, the method comprising the steps of:
a) opening the valves at the passages in a first set of gas tank and valve arrangements, wherein said first set is taken out of the plurality of gas tank and valve arrangements, and wherein the first set of gas tank and valve arrangements comprises at least two gas tank and valve arrangements;
b) determining a first pressure value at a gas transportation arrangement downstream all of said valves which have been opened;
c) closing the passage at all gas tank and valve arrangements by closing at least one valve at each such passage, except for one gas tank and valve arrangement, for which said at least one valve at the passage of the gas tank and valve arrangement is not closed, wherein said one gas tank and valve arrangement is comprised in said first set;
d) waiting a pre-determined amount of time, and/or letting a pre-determined amount of gas from the gas tank system pass the location where said first pressure has been determined;
e) determining a second pressure value at said gas transportation arrangement downstream the gas and tank and valve arrangement whose valve have not been closed in step c); and
f) determining whether said at least one valve which has not been closed in step c) operates properly based on said first and said second determined pressure values.

2. The method according to claim 1, wherein said determining whether said at least one valve which has not been closed in step c) operates properly is based on whether said second determined pressure value deviates more than a pre-determined threshold from said first determined pressure value.

3. The method according to claim 1, wherein the steps a)-f) are repeated, and wherein the gas tank and valve arrangement with the non-closed passage in step c) is changed in each repeated run of the steps a)-f).

4. The method according to claim 1, wherein said first set of gas tank and valve arrangements corresponds to all gas tank and valve arrangements in the gas tank system.

5. The method according to claim 1, further comprising the step:
g) determining whether a set of pre-determined conditions is fulfilled,
and wherein the steps a)-f) only are performed once said set of pre-determined conditions is fulfilled.

6. The method according to claim 5, wherein step g) is performed intermittently or continuously, and wherein the method is aborted when it is determined in step g) that said set of pre-determined conditions is not-fulfilled.

7. The method according to claim 1, further comprising the step of indicating for an operator or a service technician of the gas tank system the valve or valves which have been determined as not properly operating in step f).

8. The method according to claim 1, used for determining the proper operation of a valve in a gas tank system of a vehicle.

9. A system for determining the proper operation of a valve in a gas tank system, wherein the gas tank system comprises a plurality of gas tank and valve arrangements, each gas tank and valve arrangement comprising a gas tank and at least one valve arranged at a passage downstream said gas tank, the system comprising:
means for opening the valves at the passages in a first set of gas tank and valve arrangements, wherein said first set of gas tank and valve arrangements is taken out of the plurality of gas tank and valve arrangements, and wherein the first set comprises at least two gas tank and valve arrangements;
means for determining a first pressure value at a gas transportation arrangement downstream all of said valves which have been opened;
means for closing the passage at all gas tank and valve arrangements by closing at least one valve at each such passage, except for one gas tank and valve arrangement, for which said at least one valve at the passage of the gas tank and valve arrangement is not closed, wherein said one gas tank and valve arrangement is comprised in said first set;
means for determining that a pre-determined amount of time has passed, and/or means for determining that a pre-determined amount of gas from the gas tank system has passed the location where said first pressure has been determined;
means for determining a second pressure value at said gas transportation arrangement downstream the gas and tank and valve arrangement whose valve(s) have not been closed; and
means for determining whether said at least one valve which has not been closed operates properly based on said first and said second determined pressure values.

10. The system according to claim 9, further comprising means for determining whether a set of pre-determined conditions is fulfilled.

11. The system according to claim 9, further comprising means for indicating for an operator or a service technician of the gas tank system the valve or valves which have been determined as not properly operating.

12. A gas tank system comprising: claim 9
a plurality of gas tank and valve arrangements, each gas tank and valve arrangement comprising a gas tank and at least one valve (220a, 221a, 220b, . . . ) arranged at a passage downstream said gas tank; and
a system comprising:
means for opening the valves at the passages in a first set of gas tank and valve arrangements, wherein said first set of gas tank and valve arrangements is taken out of the plurality of gas tank and valve arrangements, and wherein the first set comprises at least two gas tank and valve arrangements;
means for determining a first pressure value at a gas transportation arrangement downstream all of said valves which have been opened;
means for closing the passage at all gas tank and valve arrangements by closing at least one valve at each such passage, except for one gas tank and valve arrangement, for which said at least one valve at the passage of the gas tank and valve arrangement is not closed, wherein said one gas tank and valve arrangement is comprised in said first set;
means for determining that a pre-determined amount of time has passed, and/or means for determining that a pre-determined amount of gas from the gas tank system has passed the location where said first pressure has been determined;
means for determining a second pressure value at said gas transportation arrangement downstream the gas and tank and valve arrangement whose valve have not been closed; and
means for determining whether said at least one valve which has not been closed operates properly based on said first and said second determined pressure values.

13. A vehicle, comprising
a gas tank system comprising:
a plurality of gas tank and valve arrangements, each gas tank and valve arrangement comprising a gas tank and at least one valve (220a, 221a; 220b, . . . ) arranged at a passage downstream said gas tank; and
a system comprising:
means for opening the valves at the passages in a first set of gas tank and valve arrangements, wherein said first set of gas tank and valve arrangements is taken out of the plurality of gas tank and valve arrangements, and wherein the first set comprises at least two gas tank and valve arrangements;
means for determining a first pressure value at a gas transportation arrangement downstream all of said valves which have been opened;
means for closing the passage at all gas tank and valve arrangements by closing at least one valve at each such passage, except for one gas tank and valve arrangement, for which said at least one valve at the passage of the gas tank and valve arrangement is not closed, wherein said one gas tank and valve arrangement is comprised in said first set;
means for determining that a pre-determined amount of time has passed, and/or means for determining that a pre-determined amount of gas from the gas tank system has passed the location where said first pressure has been determined;
means for determining a second pressure value at said gas transportation arrangement downstream the gas and tank and valve arrangement whose valve have not been closed; and
means for determining whether said at least one valve which has not been closed operates properly based on said first and said second determined pressure values.

14. (canceled)

15. A computer program product stored on a non-transitory computer-readable medium, said computer program product for determining the proper operation of a valve in a gas tank system, wherein the gas tank system comprises a plurality of gas tank and valve arrangements, each gas tank and valve arrangement comprising a gas tank and at least one valve arranged at a passage downstream of said gas tank, said computer program product comprising computer instructions to cause one or more electronic control units or computers to perform the following operations:
a) opening the valves at the passages in a first set of gas tank and valve arrangements, wherein said first set is taken out of the plurality of gas tank and valve arrangements, and wherein the first set of gas tank and valve arrangements comprises at least two gas tank and valve arrangements;
b) determining a first pressure value at a gas transportation arrangement downstream all of said valves which have been opened;
c) closing the passage at all gas tank and valve arrangements by closing at least one valve at each such passage, except for one gas tank and valve arrangement, for which said at least one valve at the passage of the gas tank and valve arrangement is not closed, wherein said one gas tank and valve arrangement is comprised in said first set;
d) waiting a pre-determined amount of time, and/or letting a pre-determined amount of gas from the gas tank system pass the location where said first pressure has been determined;
e) determining a second pressure value at said gas transportation arrangement downstream the gas and tank and valve arrangement whose valve have not been closed in step c); and
f) determining whether said at least one valve which has not been closed in step c) operates properly based on said first and said second determined pressure values.
